(19) United States
(12) Patent Application Publication
(10) Pub. No.: US 2022/0041030 A1
(43) Pub. Date: Feb. 10, 2022

(54) ACTIVE ROLL CONTROL SYSTEM

(71) Applicant: GM GLOBAL TECHNOLOGY OPERATIONS LLC, Detroit, MI (US)

(72) Inventors: Brian K. Saylor, South Lyon, MI (US); Robert G. Izak, Dryden, MI (US); Larry G. Gepfrey, Fenton, MI (US)

(21) Appl. No.: 16/989,630

(22) Filed: Aug. 10, 2020

(51) Int. Cl. B60G 21/055

(52) U.S. Cl. CPC B60G 21/0555; B60G 2204/62; B60G 2600/181; B60G 2400/0521; B60G 2401/20; B60G 2400/0511

(57) ABSTRACT

A vehicle, system and method of controlling a roll of the vehicle is disclosed. The system includes a roll control actuator, a first switch, a second switch and a processor. The first switch is configured to couple the roll control actuator to a first power source. The second switch configured to control an electrical connection between the roll control actuator and ground. The processor is configured to operate the first switch to electrically decouple the roll control actuator from the first power source and operate a second switch to ground to short the ARC motor to ground to control the roll of the vehicle.

### INTRODUCTION

The subject disclosure relates to active roll control systems for a vehicle and, in particular, to a method of operating an active roll control system during a loss of power from a power source.

An active roll control system is a system designed to reduce a roll of a vehicle, for example, in turns and is generally powered by connecting the system to a high power source, such as a car battery. However, if the high power source fails or is otherwise disconnected from the active roll control system, the system is allowed to freewheel, which can cause undesirable vehicular motion and/or a loss of vehicle stability control. Accordingly, it is desirable to provide control of the active roll control system during a loss of power from the high power source.

### SUMMARY

In one exemplary embodiment, a method of controlling a roll of a vehicle is disclosed. A roll control actuator is electrically decoupled from a first power source via a first switch. A second switch is operated to short the roll control actuator to ground to control the roll of the vehicle.

In addition to one or more of the features described herein, the second switch is operated to control an electrical connection of the roll control actuator between a ground configuration and a freewheel configuration. The second switch is operated using a control signal that is pulse width modulated. A duty cycle of the control signal is controlled based on one of a roll angle of the vehicle and a roll velocity of the vehicle. The duty cycle of the control signal can be increased as the roll angle returns to a center position. Operating the second switch further includes operating one of a mechanical switch and a field effect transistor. In an embodiment in which, the roll control actuator includes a front wheel active roll control (ARC) actuator and a rear wheel ARC actuator, the front wheel ARC actuator is controlled by using a first control signal to provide a first roll resistance at front wheels of the vehicle and the rear wheel ARC actuator is controlled by using a second control signal to provide a second roll resistance at rear wheels of the vehicle, thereby providing a selected front roll resistance to rear wheel roll resistance distribution for the vehicle.

In another exemplary embodiment, a system for controlling a roll of a vehicle is disclosed. The system includes a roll control actuator, a first switch configured to couple the roll control actuator to a first power source, a second switch configured to control an electrical connection between the roll control actuator and ground, and a processor. The processor is configured to operate the first switch to electrically decouple the roll control actuator from the first power source and operate a second switch to ground to short the roll control actuator to ground to control the roll of the vehicle.

In addition to one or more of the features described herein, the processor is further configured to operate the second switch to control an electrical connection of the roll control actuator between a ground configuration and a freewheel configuration. The processor is further configured to operate the second switch using a control signal that is pulse width modulated. The processor is further configured to control a duty cycle of the control signal based on one of a roll angle of the vehicle and a roll velocity of the vehicle. The processor is further configured to increase a duty cycle of the control signal as the roll angle returns to a center position. The second switch can be one of a mechanical switch and a field effect transistor. In an embodiment, the roll control actuator includes a front wheel active roll control (ARC) actuator and a rear wheel ARC actuator and the processor is configured to control the front wheel ARC actuator using a first control signal to provide a first roll resistance at front wheels of the vehicle and to control the rear wheel ARC actuator using a second control signal to provide a second roll resistance at rear wheels of the vehicle to provide a selected front roll resistance to rear wheel roll resistance distribution for the vehicle.

In yet another exemplary embodiment, a vehicle is disclosed. The vehicle includes a roll control actuator, a first switch configured to couple the roll control actuator to a first power source, a second switch configured to control an electrical connection between the roll control actuator and a second power source, and a processor. The processor is configured to operate the first switch to electrically decouple the roll control actuator from the first power source and operate a second switch to short the roll control actuator to ground to control the roll of the vehicle.

In addition to one or more of the features described herein, the processor is further configured to operate the second switch to control the electrical connection of the roll control actuator between a ground configuration and a freewheel configuration. The processor is further configured to operate the second switch using a control signal that is pulse width modulated. The processor is further configured to control a duty cycle of the control signal based on one of a roll angle of the vehicle and a roll velocity of the vehicle. The processor is further configured to increase a duty cycle of the control signal as the roll angle returns to a center position. In an embodiment, the roll control actuator further includes a front wheel active roll control (ARC) actuator and a rear wheel ARC actuator and the processor is further configured to control the front wheel ARC actuator using a first control signal to provide a first roll resistance at front wheels of the vehicle and to control the rear wheel ARC actuator using a second control signal to provide a second roll resistance at rear wheels of the vehicle to provide a selected front roll resistance to rear wheel roll resistance distribution for the vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle having an active roll control system, in an exemplary embodiment;

FIG. 2 shows a circuit diagram of the active roll control system in an illustrative embodiment;

FIG. 3 shows a roll control diagram obtained using the active roll control system of FIG. 2 operating in a failure mode;

FIG. 4 shows a circuit diagram of the active roll control system in an alternate embodiment;

FIG. 5 shows a roll control diagram obtained using the active roll control system of FIG. 4 during a failure mode of operation;

FIG. 6 shows a roll control diagram based on using the active roll control system shown in FIG. 4 to control roll angle based on a roll angle velocity;

FIG. 7 shows an active roll control system suitable for controlling the roll angle using both front wheels and back wheels; and

FIG. 8 shows a flowchart illustrating a method for operating an active roll control system.

### DETAILED DESCRIPTION

The following description is merely exemplary in nature and is not intended to limit the present disclosure, its application or uses.

In accordance with an exemplary embodiment, FIG. 1 shows a vehicle 100 having an active roll control system (ARC system 102). The ARC system 102 controls a roll of the vehicle 100 as it rolls away from center to one side or the other, such as when vehicle 100 makes a turn. A driver side sensor 104a is associated with a driver side of the vehicle 100 or a driver side tire 106a. A passenger side sensor 104b is associated with a passenger side of the vehicle 100 or a passenger side tire 106b. The driver side sensor 104a and the passenger side sensor 104b provide signals that can be used to determine a roll angle of the vehicle 100. In one embodiment, the driver side sensor 104a and the passenger side sensor 104b are electrical sensors that each measure an electrical parameter, such as a current or resistance, that is related to a center position of a respective vehicle corner's wheel. The ARC system 102 determines the roll angle on the electrical parameter measurements and controls the roll of the vehicle accordingly. In particular, the ARC system 102 determines the roll angle based on a difference between the electrical parameters.

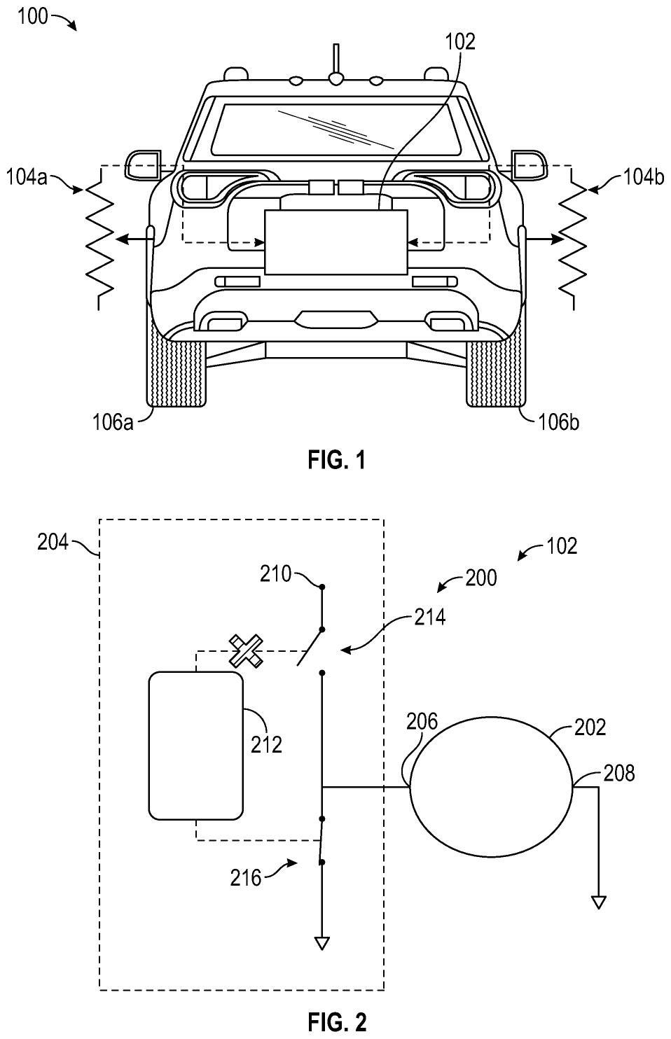

FIG. 2 shows a circuit diagram 200 of the ARC system 102 in an illustrative embodiment. The ARC system 102 includes a roll control actuator (also referred to herein as an active roll control actuator or ARC actuator 202) for controlling the roll angle of the vehicle 100 and a power circuit 204 for supplying power to the ARC actuator 202. The ARC actuator 202 includes a high power lead (HP lead 206) that connects to the power circuit 204 and a ground lead 208 that connects to ground.

The power circuit 204 includes a first power source (i.e., high power source 210) and a second power source (e.g., low power controls 212). The high power source 210 is a source supplying about 48 V, such as a car battery. The low power controls 212 supplies about 12 V and can include an auxiliary battery or power source for supplying power to a radio, GPS, sound system, etc., of the vehicle. The power circuit 204 also includes a first switch (i.e., high power switch 214) and a second switch (i.e., ground switch 216), both of which can be mechanical switches operated by either electric or mechanical relay. In one embodiment, the high power switch 214 and the ground switch 216 are both single pole double throw (SPDT) switches. The HP lead 206 of the ARC actuator 202 is electrically connected to the power circuit 204 between the high power switch 214 and the ground switch 216.

The low power controls 212 include a processor for controlling the configuration of both the high power switch 214 and the ground switch 216 in order to control operation of the ARC actuator 202. The HP lead 206 can be connected to the high power source 210 by closing the high power switch 214 and opening the ground switch 216. This configuration provides a normal mode of operation for the ARC system 102. When a power disruption occurs at the high power source 210, the high power switch 214 can be placed in an open configuration, as shown in FIG. 2, thereby electrically decoupling the ARC actuator 202 from the high power source 210 and placing the ARC system 102 in a failure mode of operation.

With the high power switch 214 in the open configuration, power is regenerated by the ARC actuator 202 as it is driven by input from the wheels. With the ground switch 216 in a grounding configuration, as shown in FIG. 2, the HP lead 206 of the ARC actuator 202 is electrically connected to ground significantly increasing the torque required to rotate the ARC's motor. With the ground switch 216 in a power configuration, the HP lead 206 is electrically connected to the ground by the low power controls 212.

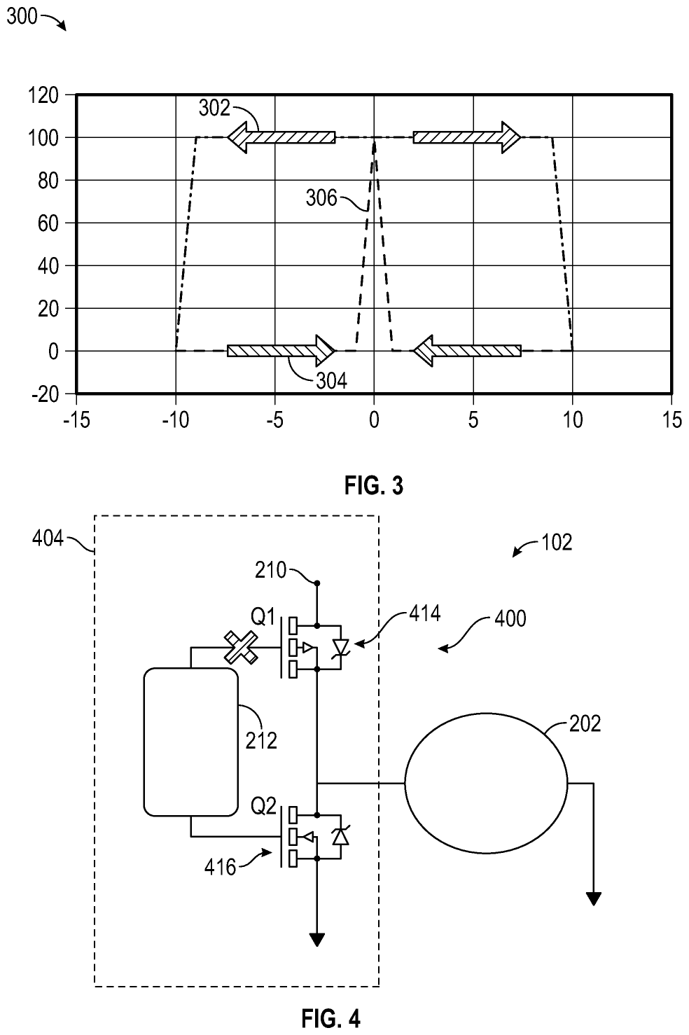

FIG. 3 shows a roll control diagram 300 obtained using the ARC system 102 of FIG. 2 operating in a failure mode. The roll control diagram 300 shows roll angle along the abscissa and a continuity to ground along the ordinate axis. The roll angle is measured in degrees, with zero degrees indicating the vehicle in a neutral or center position (i.e., with a medial plane of the vehicle extending vertically). The continuity to ground indicates a percentage of time during which the ARC actuator 202 is coupled to ground by operation of the ground switch 216. A continuity to ground of 100% indicates a short of the ARC actuator 202 to ground, while a continuity to ground of 0% indicates no connection to ground. The roll control diagram 300 indicates operation of the ground switch 216 at several roll angles of the vehicle. Rolling is shown for both the left side and right side of the vehicle.

As the vehicle rolls away from center along roll-out curve 302, the ground switch 216 is configured to short the ARC actuator 202 to ground. This configuration provides a resistance in the chassis to the rolling away from center. When the roll angle reaches a maximum or substantial maximum, the ground switch 216 is configured to disconnect the ARC actuator 202 from ground allowing it to free wheel. The ARC actuator 202 thus allows the vehicle to roll back to center with little or no resistance, as shown by roll-in curve 304. At a selected roll angle (e.g., about 0.5 degree from vertical), the ground switch 216 can be reconfigured to short the ARC actuator 202 to ground, as shown by roll-in curve 306.

FIG. 4 shows a circuit diagram 400 of the ARC system 102 in an alternate embodiment. The ARC system 102 includes the ARC actuator 202 and a power circuit 404 for supplying power to the ARC actuator 202. The power circuit 404 includes the high power source 210 and the low power controls 212. The power circuit further includes high power switch 414 and ground switch 416 which are FETs (field effect transistors) such as a MOSFETs (Metal Oxide Semiconductor Field Effect Transistors). The low power controls 212 electronically controls the high power switch 414 to connect or disconnect the ARC actuator 202 from the high power source 210. The low power controls 212 electrically controls the ground switch 416 to control an electrical connection between the ARC actuator 202 and either the lower power source or ground. The low power controls 212 apply a control signal such as a pulse width modulated (PWM) signal to the ground switch 416. The PWM signal includes a waveform generally in the form of a rectangular wave having an on-state at maximum voltage and an off-state at zero volts. A duty cycle of the PWM signal is a ratio indicating a portion of a cycle of the PWM signal during which the signal is in the on-state vs. the off-state. An 80% duty cycle indicates that the waveform is in the on-state for 80% of the wave cycle and in the off-state for 20% of the wave cycle, while a 20% duty cycle indicates that the waveform in in the on-state for 20% of the wave cycle and in the off-state for 80% of the wave cycle. The low power controls 212 can adjust the duty cycle of the control signal.

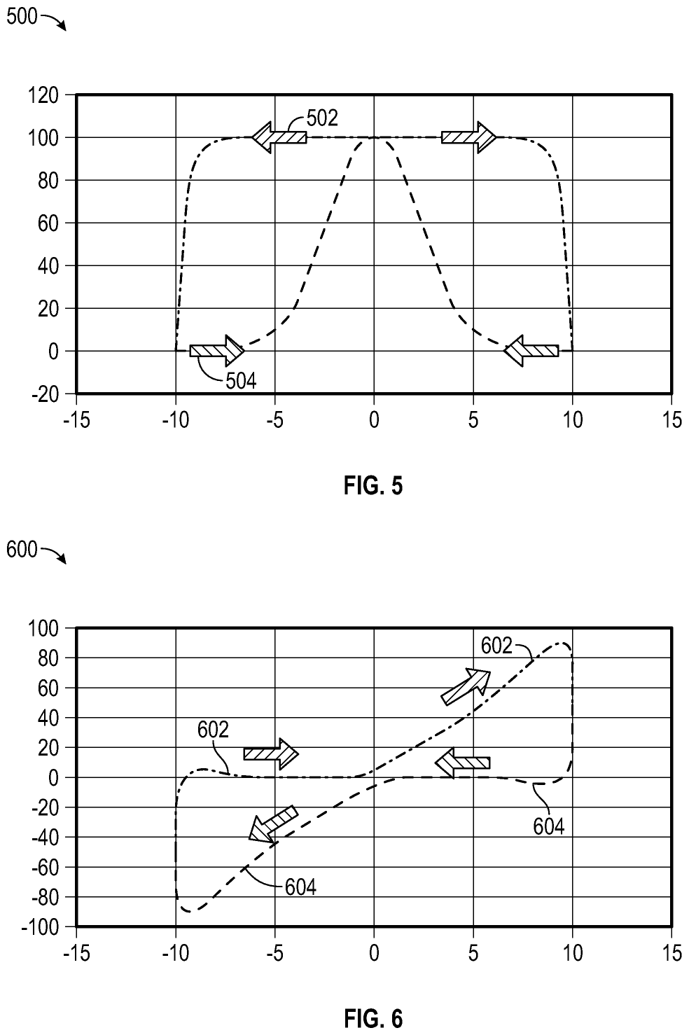

FIG. 5 shows a roll control diagram 500 obtained using the ARC system 102 of FIG. 4 during a failure mode of operation. Roll angle is shown along the abscissa is in degrees and a continuity to ground is shown along the ordinate axis as a percentage. As the vehicle rolls away from center along roll-out curve 502, the ground switch 416 is configured to short the ARC actuator 202 to ground, thereby providing a resistance to the roll during the roll away from center. When the roll angle reaches a maximum or substantial maximum, the ground switch 416 is configured to disconnect the ARC actuator 202 from the low power ground via low power controls 212, allowing it to free wheel. As the vehicle rolls back to center, the low power controls 212 apply the control signal at a relatively low duty cycle (e.g., 0% duty cycle) and increases the duty cycle as the roll angle returns to center. Thus, as the vehicle rolls back to center, the amount of resistance applied against the roll increases, eventually returning to its original resistance levels (e.g., 100% duty cycle). The roll-out curve 504 shows the gradual change in the duty cycle as the roll angle returns to center.

FIG. 6 shows a roll control diagram 600 based on using the ARC system 102 shown in FIG. 4 to control roll angle based on a roll angle velocity. Roll angle velocity is shown along the abscissa and continuity to ground is shown along the ordinate axis. Curve 602 shows a clockwise rotation of the vehicle and curve 604 shows a counterclockwise rotation of the vehicle. Curve 602 shows a roll resistance that is applied only as the roll angle returns to center.

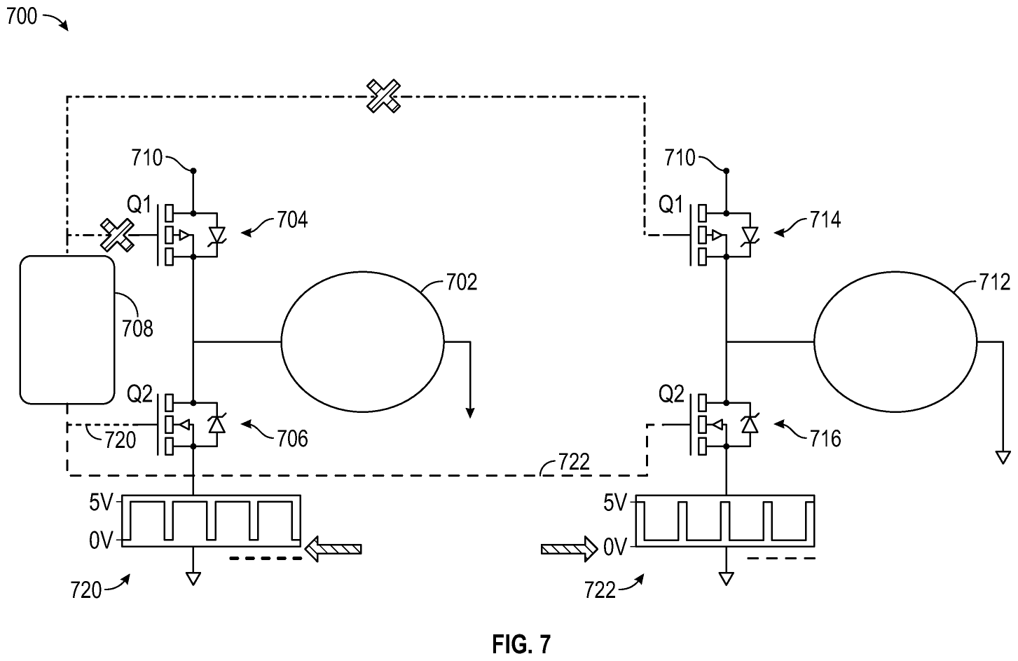

FIG. 7 shows an ARC system 700 suitable for controlling the roll angle using both front wheels and back wheels. The ARC system 700 can be used to perform tire lateral load transfer distribution (TLLTD) in order to control roll resistance at each of the front wheels and back wheels independently. The ARC system 700 includes a front wheel ARC actuator 702 and a rear wheel ARC actuator 712, both of which can operate according to the methods disclosed herein with respect to FIG. 4. The front wheel ARC actuator 702 can be coupled to a high power source 710 via front high power switch 704 and can be coupled to ground via front ground switch 706. Similarly, the rear wheel ARC actuator 712 can be coupled to the high power source 710 via rear high power switch 714 and coupled to ground via rear ground switch 716. The front high power switch 704 and front ground switch 706 can be operated independently from the rear high power switch 714 and rear ground switch 716. The switches can be FETs.

Low power controls 708 control the configurations of each of these switches. In a failure mode of operation, the low power controls 708 open both the front high power switch 704 and a the rear high power switch 714 to disconnect their respective ARC actuators from the high power source 710. The low power controls 708 then sends a first control signal 720 to the front ground switch 706 and a second control signal 722 to the rear ground switch 716. The first control signal 720 has a first duty cycle and the second control signal 722 has a second duty cycle (as shown in FIG. 7 as waveforms alternating between 0 Volts and 5 Volts).

The first duty cycle and second duty cycle can be selected to control a relative roll resistance between the front wheels and the rear wheels. In various embodiments, the first duty cycle is greater than the second duty cycle, therefore operating the front wheel ARC actuator 702 to provide a first roll resistance at the front wheels and operating the rear wheel ARC actuator 712 to provide a second roll resistance at the rear wheels. The first roll resistance is greater than the second roll resistance. As shown in FIG. 7 for illustrative purposes only, the first duty cycle is 80% while the second duty cycle is 20%. A ratio between the first duty cycle and the second duty cycle can be adjusted as the roll angle of the vehicle returns to center so that the front wheels and rear wheels have an optimal roll resistance distribution at a center of the vehicle An optimal roll resistance distribution can include a selected ratio between front wheel roll resistance and rear wheel roll resistance, which can be a specified ratio for the vehicle based on vehicle type.

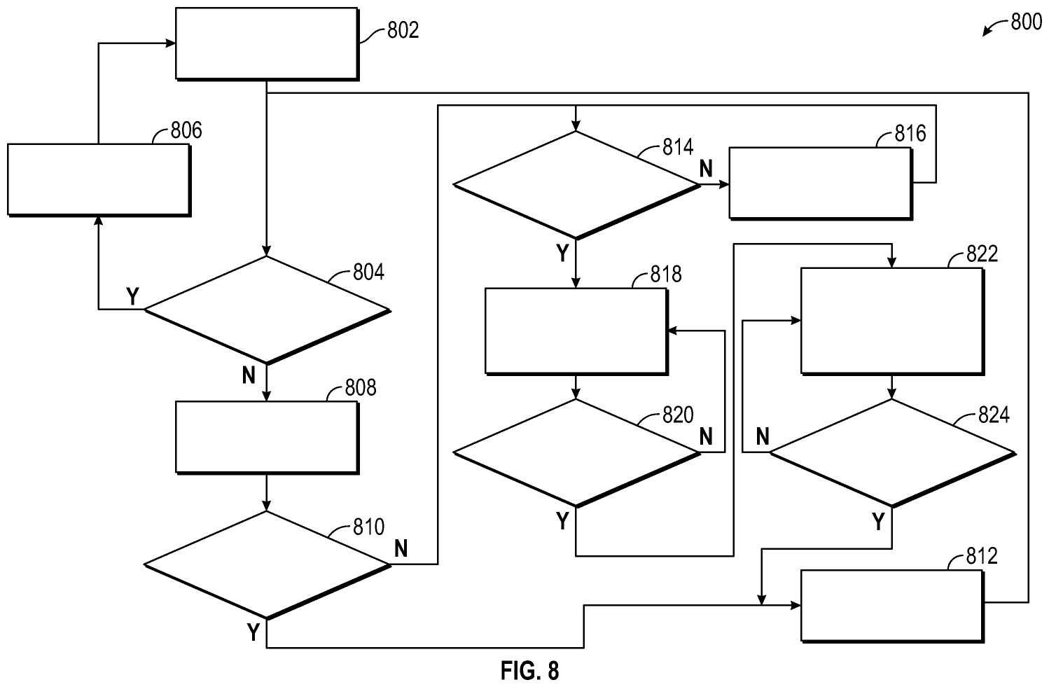

FIG. 8 shows a flowchart 800 illustrating a method for operating an active roll control system. The method begins at box 802 with an ARC actuator operating under normal roll stiffness in a normal mode of operation.

In box 804, the method determines whether the high power source has turned off or is faulty. If the high power source is still operating correctly (i.e., the high power source is still on), the method proceeds to box 806 in which the ARC actuator remains connected to the high power source. From box 806, the method proceeds to box 802 to monitor the high power source. Returning to box 804, if the high power source is not operating correctly, the method proceeds to box 808. In box 808, the ARC actuator is disconnected from the high power source.

In box 810, the method determines if the vehicle roll angle is at center (i.e., at zero degrees from vertical). If the roll angle is at center, the method proceeds to box 812. In box 812, the HP lead of the ARC actuator is connected to ground and the method proceeds back to box 804. Returning to box 810, if the roll angle is not at center, the method proceeds to box 814.

In box 814, a determination is made as to whether the roll angle is decreasing (i.e., returning to center). If the roll angle is not decreasing (i.e., steady or increasing), the method proceeds to box 816. In box 816, the HP lead is connected to ground or maintained at ground. The method then returns to box 814. Returning to box 814, if the roll angle is decreasing, the method proceeds to box 818. In box 818, the HP power lead is disconnected from ground, allowing the ARC to freewheel.

In box 820, a determination is made as to whether the roll angle is approaching zero degrees, as defined by a selected criterion. If the roll angle is not approaching zero degrees within the selected criterion, the method returns to box 818. If, however at box 820, the roll angle is within the selected criterion, the method proceeds to box 822. In box 822, the PWM control signal is used to control the return to zero degrees by controlling the electrical connection of the HP lead to ground.

In box 824, a determination is made whether the roll angle is zero or substantially zero, to within a selected error. If the roll angle is not zero, then the method returns to box 822 and the control signal is still applied. Returning to box 824, if the roll angle is zero, the method proceeds to box 812. In box 812, the HP lead is connected to ground and the method proceeds back to box 804.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method of controlling a roll of a vehicle, comprising:
electrically decoupling a roll control actuator from a first power source via a first switch; and
operating a second switch to short the roll control actuator to ground to control the roll of the vehicle.

2. The method of claim 1, further comprising operating the second switch to control an electrical connection of the roll control actuator between a ground configuration and a freewheel configuration.

3. The method of claim 1, further comprising operating the second switch using a control signal that is pulse width modulated.

4. The method of claim 3, further comprising controlling a duty cycle of the control signal based on one of: (i) a roll angle of the vehicle; and (ii) a roll velocity of the vehicle.

5. The method of claim 3, further comprising increasing a duty cycle of the control signal as a roll angle returns to a center position.

6. The method of claim 1, wherein operating the second switch further comprises operating one of: (i) a mechanical switch; and (ii) a field effect transistor.

7. The method of claim 1, wherein the roll control actuator further includes a front wheel active roll control (ARC) actuator and a rear wheel ARC actuator, further comprising controlling the front wheel ARC actuator using a first control signal to provide a first roll resistance at front wheels of the vehicle and controlling the rear wheel ARC actuator using a second control signal to provide a second roll resistance at rear wheels of the vehicle to provide a selected front roll resistance to rear wheel roll resistance distribution for the vehicle.

8. A system for controlling a roll of a vehicle, comprising:
a roll control actuator;
a first switch configured to couple the roll control actuator to a first power source;
a second switch configured to control an electrical connection between the roll control actuator and ground; and
a processor configured to:
operate the first switch to electrically decouple the roll control actuator from the first power source; and
operate a second switch to ground to short the roll control actuator to ground to control the roll of the vehicle.

9. The system of claim 8, wherein the processor is further configured to operate the second switch to control an electrical connection of the roll control actuator between a ground configuration and a freewheel configuration.

10. The system of claim 8, wherein the processor is further configured to operate the second switch using a control signal that is pulse width modulated.

11. The system of claim 10, wherein the processor is further configured to control a duty cycle of the control signal based on one of: (i) a roll angle of the vehicle; and (ii) a roll velocity of the vehicle.

12. The system of claim 10, wherein the processor is further configured to increase a duty cycle of the control signal as a roll angle returns to a center position.

13. The system of claim 8, wherein the second switch is one of: (i) a mechanical switch; and (ii) a field effect transistor.

14. The system of claim 8, wherein the roll control actuator further includes a front wheel active roll control (ARC) actuator and a rear wheel ARC actuator, wherein the processor is further configured to control the front wheel ARC actuator using a first control signal to provide a first roll resistance at front wheels of the vehicle and to control the rear wheel ARC actuator using a second control signal to provide a second roll resistance at rear wheels of the vehicle to provide a selected front roll resistance to rear wheel roll resistance distribution for the vehicle.

15. A vehicle, comprising:
a roll control actuator;
a first switch configured to couple the roll control actuator to a first power source;
a second switch configured to control an electrical connection between the roll control actuator and a second power source; and
a processor configured to:
operate the first switch to electrically decouple the roll control actuator from the first power source; and
operate a second switch to short the roll control actuator to ground to control the roll of the vehicle.

16. The vehicle of claim 15, wherein the processor is further configured to operate the second switch to control the electrical connection of the roll control actuator between a ground configuration and a freewheel configuration.

17. The vehicle of claim 15, wherein the processor is further configured to operate the second switch using a control signal that is pulse width modulated.

18. The vehicle of claim 17, wherein the processor is further configured to control a duty cycle of the control signal based on one of: (i) a roll angle of the vehicle; and (ii) a roll velocity of the vehicle.

19. The vehicle of claim 17, wherein the processor is further configured to increase a duty cycle of the control signal as a roll angle returns to a center position.

20. The vehicle of claim 15, wherein the roll control actuator further includes a front wheel active roll control (ARC) actuator and a rear wheel ARC actuator, wherein the processor is further configured to control the front wheel ARC actuator using a first control signal to provide a first roll resistance at front wheels of the vehicle and to control the rear wheel ARC actuator using a second control signal to provide a second roll resistance at rear wheels of the vehicle to provide a selected front roll resistance to rear wheel roll resistance distribution for the vehicle.
